(19) United States
(12) Patent Application Publication
(10) Pub. No.: US 2016/0090873 A1
(43) Pub. Date: Mar. 31, 2016

(54) SYSTEM FOR EVAPORATING LIQUEFIED NATURAL GAS (LNG)

(71) Applicant: ROBERT BOSCH GMBH, Stuttgart (DE)

(72) Inventors: Simon WEISSENMAYER, Flein (DE); Martin HUBER, Affalterbach (DE)

(21) Appl. No.: 14/891,210

(22) PCT Filed: Mar. 31, 2014
(86) PCT No.: PCT/EP2014/056399

§ 371 Date: Nov. 13, 2015

(30) Foreign Application Priority Data
May 13, 2013 (DE) 10 2013 208 701.2

(51) Int. Cl. F01K 23/10; F01N 5/02; F02M 21/06

(52) U.S. Cl. CPC F01K 23/10; F02M 21/06; F01N 5/02

(57) ABSTRACT

A system for evaporating liquefied natural gas (LNG) in a vehicle having an engine which is powered by natural gas, the system including an evaporator for the LNG, and the system including a heat engine for recovering the thermal energy from the exhaust gas of the vehicle, the heat engine including a condenser for condensing a coolant, this condenser being in operative connection with the evaporator for the LNG for the purpose of exchanging heat.

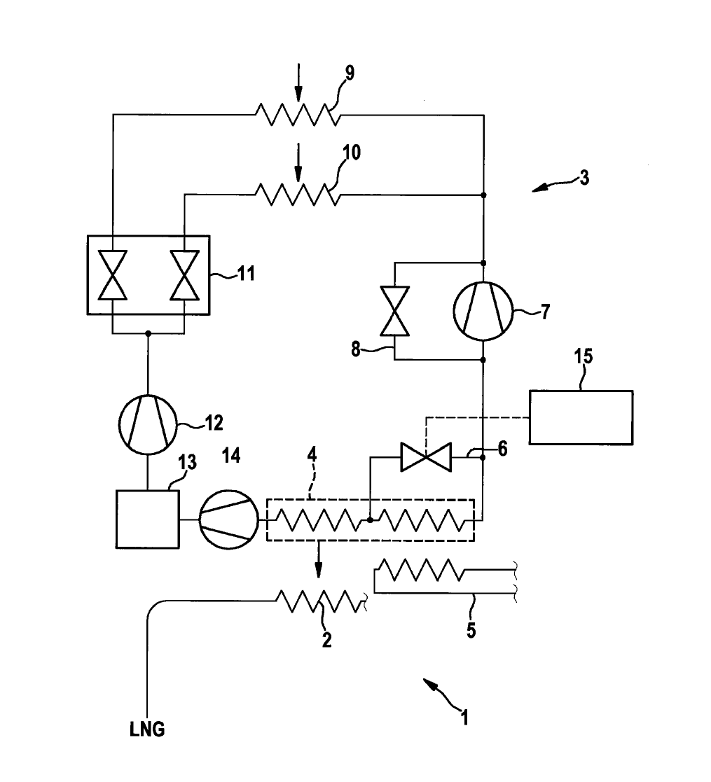

### FIELD OF THE INVENTION

The present invention relates to a system for evaporating liquefied natural gas (LNG) in a vehicle having an engine which is powered by natural gas.

### BACKGROUND INFORMATION

An exhaust gas heat engine may be used to recover a portion of the thermal energy of the exhaust gas of a vehicle and thus to increase the efficiency of the engine, in particular of trucks. With the aid of this exhaust gas heat engine, it is possible to save approximately 5% of the fuel.

Vehicles which are powered by an internal combustion engine using natural gas as the fuel have been known for a long time and are referred to as a natural gas vehicle (NGV), a natural gas car, or a CNG vehicle (CNG=compressed natural gas). A processed natural gas/air mixture is combusted in the cylinders of the internal combustion engine. To achieve a sufficient energy density, the compressed natural gas (CNG) is compressed to approximately 200 bar and stored. A conventional gasoline engine is used as the internal combustion engine. In the commercial vehicle field, there are retrofitted diesel engines which are able to use natural gas as the fuel, e.g., the DING (direct injection natural gas) engine. Liquefied natural gas (LNG) is increasingly used in particular in the USA and in Asia as the fuel for trucks. The natural gas is present in liquefied form and is evaporated when it is retrieved from the tank of the vehicle. The evaporator is heated with the aid of the cooling fluid from the cooling circuit of the engine.

Natural gas, whose essential element is methane, may be combusted very cleanly. In comparison to gasoline vehicles, less carbon dioxide, less carbon monoxide, and less hydrocarbons are formed. In comparison to diesel vehicles, overall less carbon monoxide, less hydrocarbons, less nitrogen oxides, and almost no soot particles are formed. Natural gas for powering motor vehicles may also be obtained very easily from biogas with the aid of processing. Bio natural gas and fossil natural gas may then be present in a mixed form. Bio natural gas may be obtained from spoiled food products, for example, or from other biodegradable waste. The regenerative energy recovery of natural gas is thus not directly competing with the food production (offset of problems with other biofuels). Natural gas is one of the few regenerative energy carriers which may be stored over a long time (over several months) and will thus play an increasingly more important role in the future for powering vehicles.

In order to liquefy the natural gas for storage as an LNG, approximately 10% to 25% of the energy content of the gas are needed. This energy is lost when the LNG is heated up (evaporated) by the cooling fluid from the cooling circuit of the engine.

The energy which is lost during the heating up of the LNG is supposed to be recovered at least partially in order to improve the energy balance of a natural gas vehicle.

### SUMMARY

The present invention provides a system for evaporating liquefied natural gas (in the following “LNG”) in a vehicle having an engine which is powered by natural gas.

The system according to the present invention includes an evaporator for the LNG as well as a heat engine, in particular an exhaust gas heat engine for recovering the thermal energy of the exhaust gas of the vehicle. According to the present invention, the evaporator for the LNG is now coupled to the heat engine, the heat engine including a condenser for condensing a coolant and this condenser being in operative connection with the evaporator for the LNG for the purpose of exchanging heat.

In order to produce this heat exchange, various means are known to those skilled in the art. For example, the line of the coolant may be guided around or also through the evaporator for the LNG or the line for the LNG may be guided around or through the condenser, or both lines may be guided along one another in a heat exchanging manner. Finally, the heat exchange may take place via an additional medium.

Ideally, the heat engine may be described as a Carnot process during which the exhaust gas supplies a first heat quantity to the coolant of the heat engine, this heat exchange taking place via an evaporator which evaporates the coolant. At a high temperature and a high pressure, the vapor is used to power an expansion machine. Here, electrical and/or mechanical energy is formed. In this way, it is possible to recover a portion of the thermal energy of the exhaust gas. The coolant is subsequently supplied to a condenser in which it is condensed, whereupon it is resupplied to the evaporator with the aid of a pump.

The efficiency of the ideal Carnot process comes to

η=1−T_{U}/T_{O},

where T_{O} represents the upper temperature, i.e., the temperature of the coolant in the evaporator, and T_{U} represents the lower temperature, i.e., the temperature of the coolant in the condenser. It is apparent from the formula that the efficiency may be increased by reducing lower temperature T_{U}. This is achieved by the present invention. Due to the heat coupling of the condenser to the evaporator for the LNG, a reduction of lower temperature T_{U} may be achieved. Thus, the heat engine may be operated more effectively. Moreover, a portion of the energy which is used to liquefy the natural gas may be recovered according to the present invention. The overall efficiency of the system according to the present invention is thus higher than that of the exhaust gas heat engine alone.

The system according to the present invention is suitable, in particular, for motor vehicles which are powered by natural gas, in particular for trucks. That is to say that the cold of evaporation is preferably used to keep the LNG in the liquid state. This is in particular achieved when operating vehicles without long-lasting interruptions, as is the case with trucks.

A piston engine or a turbine has proven advantageous in practice as an expansion machine of the heat engine.

In one particularly advantageous embodiment, the condenser of the heat engine is in operative connection with a coolant circuit of the vehicle, in particular with a or the engine cooling circuit of the vehicle for the purpose of exchanging heat. With regard to the means for producing this heat exchange, the previously said analogously applies.

In this embodiment, a first and a second stage of the heat exchange may be implemented, optionally one of the two stages being used or else one of the two stages being connected upstream from the respective other stage in principle during the operation of the system and thus of the vehicle.

The operative connection between the condenser of the heat engine and the evaporator for the LNG, on the one hand, as well as between the condenser and the above-mentioned (engine) coolant circuit, on the other hand, is advantageously implemented in such a way that the coolant of the heat engine is in operative connection with the (engine) coolant circuit in a first stage and with the evaporator for the LNG in a second stage for the purpose of exchanging heat. The first stage, in particular, is connected upstream from the second stage, both stages being run through. In this way, the coolant is cooled down in two stages in order to use the cold energy of the LNG in a more targeted manner. In the first stage, the coolant is, for example, cooled down as much as possible with the aid of the cooling water of the (engine) cooling circuit and partially condensed. In the second stage, the coolant is then completely condensed in the LNG evaporator.

In this advantageous specific embodiment of the two-stage heat exchange, it is advantageous if the heat engine includes a bypass line which guides the coolant of the heat engine past the first stage. In particular during the warmup of the vehicle engine, the cooling water in the (engine) cooling circuit is still cold (ambient temperature). The same applies to the coolant in the heat engine, the temperature of which, however, rises more rapidly than that of the (engine) cooling circuit due to the heat of the exhaust gas. In order for sufficient heat to be subsequently available for evaporating the LNG, it is meaningful to guide a portion or the entire coolant flow of the heat engine past the above-mentioned first stage and to supply it directly to the second stage. For this purpose, a control unit may be preferably provided which controls the corresponding valves in such a way that the coolant of the heat engine is guided through the bypass line as long as the temperature in the (engine) cooling circuit falls below a predefined temperature (e.g., the operating temperature).

Further advantages and embodiments of the present invention result from the description and the appended drawing.

It is understood that the above-mentioned features and the features to be elucidated below are usable not only in the given combination, but also in other combinations or alone without departing from the scope of the present invention.

### BRIEF DESCRIPTION OF THE DRAWING

The FIGURE shows one specific embodiment of a system according to the present invention for evaporating liquefied natural gas (LNG).

### DETAILED DESCRIPTION

In the FIGURE, the heat engine is identified by reference numeral 3. Ideally, the coolant of heat engine 3 runs through a Carnot process having the efficiency indicated in the description. For this purpose, the coolant is evaporated, the vapor powers an expansion machine 7, and the coolant is subsequently condensed in order to be then pumped back to the evaporator. In detail, an evaporator 9 of the exhaust gas recirculation and an evaporator 10 of the exhaust gas system are provided for this purpose via which the waste heat is supplied (indicated by the two arrows) to the coolant which is evaporated and supplied to expansion machine 7 at 300° C. and 50 bar, for example. Expansion machine 7, in particular a piston machine or a turbine, generates mechanical and/or electrical energy. With the aid of a bypass line 8 including a valve, a portion of the vapor may be guided past expansion machine 7. This is advantageous in particular when the expansion machine is supposed to be protected against water hammer (premature condensation of the coolant in the expansion machine) during the warmup and/or more thermal energy is supposed to be made available for evaporating the LNG. The coolant is subsequently condensed in condenser 4 of the heat engine. With the aid of a condensate pump 14, the coolant may be pumped into a container 13. It in turn reaches evaporators 9 and 10 via a fluid pump 12, the portions of the coolant for these evaporators being set via a distribution valve 11 (quantity control valve).

In the illustrated, particularly advantageous specific embodiment of system 1, a two-stage heat exchange is provided. For this purpose, condenser 4 may engage in a first part in a heat exchange with coolant circuit 5 of the engine. A second part of condenser 4, which is in particular connected downstream from the first part of condenser 4 in the conveying direction of the coolant, may engage in a heat exchange (indicated by the arrow) with evaporator 2 for the LNG.

Evaporator 2 for the LNG evaporates liquefied natural gas from an LNG tank and generates in this way a compressed natural gas (CNG). Another heat exchanger (not illustrated) may be connected upstream from evaporator 2 for the purpose of air conditioning the vehicle.

During the operation of the vehicle, the two above-mentioned stages are, in particular, consecutively run through. In this way, the coolant of heat engine 3 is cooled down as much as possible in the first stage via the coolant (cooling water) of engine cooling circuit 5. In the second stage, the coolant is then condensed by the heat exchange with LNG evaporator 2. In this way, existing cold energy may be optimally used. In particular, this two-stage heat exchange may be meaningful in the case of coolants which are not cooled down sufficiently to be condensed if they only run through the second stage.

The FIGURE furthermore shows a bypass line 6, including a valve, which supplies the coolant past the first stage and directly to the second stage. For this purpose, a control unit 15 controls the valve of bypass line 6 (and, if necessary, further valves which are not illustrated here). Bypass line 6 is opened by control unit 15, in particular, when the vehicle is warming up. It is namely advantageous in this case if the coolant of heat engine 3 is immediately available for the heat exchange with LNG evaporator 2 for the purpose of evaporating the LNG without having to dissipate heat to coolant circuit 5 beforehand.

Control unit 15 may, for example, measure the temperature of the coolant in engine cooling circuit 5 and only close bypass line 6 when the temperature in the coolant circuit exceeds a predefined temperature which is sufficient for reliably and completely evaporating the LNG. The temperature of the coolant is in this case a function of the mass flows of the coolant and the LNG to be evaporated as well as their heat capacities. The evaporation heat of the LNG, the heat capacity of the heat exchanger, and the heat flow in and out of the surroundings also have an effect on the temperature. The suitable temperature may be easily determined with the aid of an experiment on the prototype.

The system according to the present invention improves the efficiency of heat engine 3, may recover a portion of the energy used to liquefy the natural gas, and, at the same time, partially recover the heat of the exhaust gas via expansion machine 7.

1-10. (canceled)

11. A system for evaporating liquefied natural gas in a vehicle having an engine which is powered by natural gas, comprising:
an evaporator for the LNG; and
a heat engine for recovering thermal energy from an exhaust gas of the vehicle, the heat engine including a condenser for condensing a coolant, the condenser being in operative connection with the evaporator for the purpose of exchanging heat.

12. The system as recited in claim 11, wherein the condenser of the heat engine is in operative connection with a coolant circuit of the vehicle for the purpose of exchanging heat.

13. The system as recited in claim 12, wherein the operative connection between the condenser of the heat engine and the evaporator for the LNG, on the one hand, and between the condenser and the coolant circuit of the vehicle, on the other hand, is implemented in a two-stage manner in such a way that the coolant of the heat engine is in operative connection with the coolant circuit of the vehicle in a first stage and with the evaporator for the LNG in a second stage for the purpose of exchanging heat.

14. The system as recited in claim 13, wherein the heat engine includes a bypass line which guides the coolant of the heat engine past the first stage.

15. The system as recited in claim 14, further comprising a control unit which is configured in such a way that the coolant of the heat engine is guided through the bypass line as long as a temperature in the coolant circuit falls below a predefined temperature.

16. The system as recited in claim 11, further comprising another heat exchanger connected upstream from the evaporator for the purpose of air conditioning the vehicle.

17. The system as recited in claim 11, wherein the heat engine includes an expansion machine for generating at least one of mechanical energy and electrical energy.

18. The system as recited in claim 17, wherein the expansion machine is one of a piston machine and a turbine.

19. The system as recited in claim 12, wherein the coolant circuit is an engine cooling circuit.

20. The system as recited in claim 11, wherein the vehicle is a truck.
